(19) United States
(12) Patent Application Publication
(10) Pub. No.: US 2017/0086400 A1
(43) Pub. Date: Mar. 30, 2017

(54) Variable Sized E-45 Aeroponic Growing System

(71) Applicants: Augstine Dolores Maes, Gilcrest, CO (US); Jo Ann Maes, Gilcrest, CO (US)

(72) Inventors: Augstine Dolores Maes, Gilcrest, CO (US); Jo Ann Maes, Gilcrest, CO (US)

(21) Appl. No.: 14/866,979

(22) Filed: Sep. 27, 2015

(51) Int. Cl. A01G 31/02

(52) U.S. Cl. CPC A01G 31/02

(57) ABSTRACT

The jag E-45 grow system is unique to the field of growing in that it contains no grow mediums, everything is self contained, and energy and water efficient. No tools are required to set up the machine making it incredibly easy to use even for beginners.

The machine is a self contained aeroponic grow machine.

Different models of machines can range in growing capacity from 1 to 30 plant systems all based on same basic design principles and foundation.

It contains no grow mediums but can be modified with mediums for root based plants.

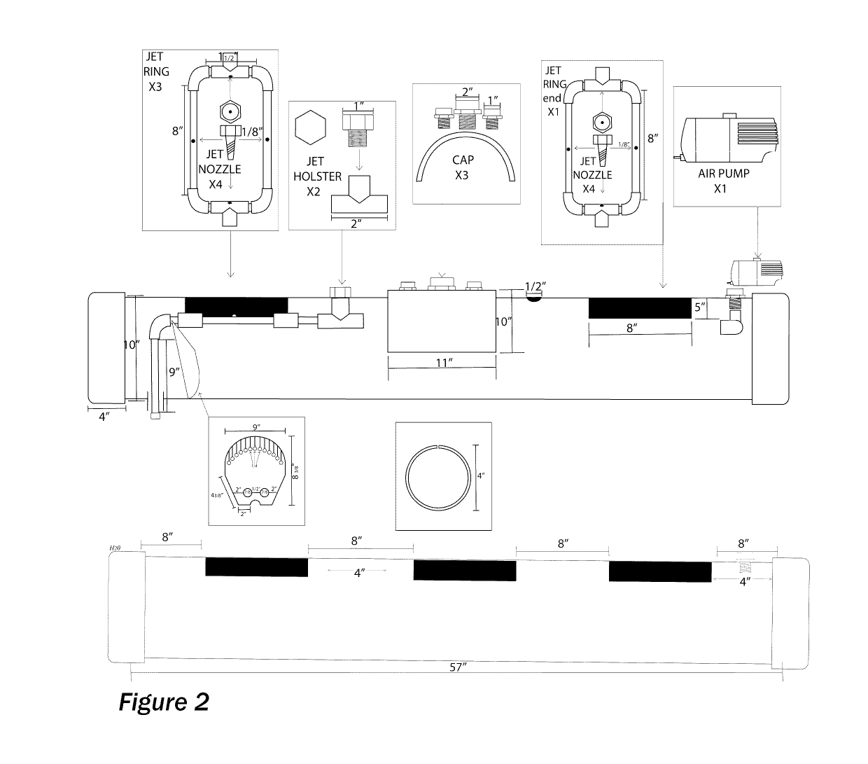

It is made of 10 inch pvc pipe growing columns that also contain originally designed root separators. Ref. FIG. 2.

Growing columns also utilize snap on adjustable column caps/covers that have plant support slots that also work as handles. Ref. FIG. 2

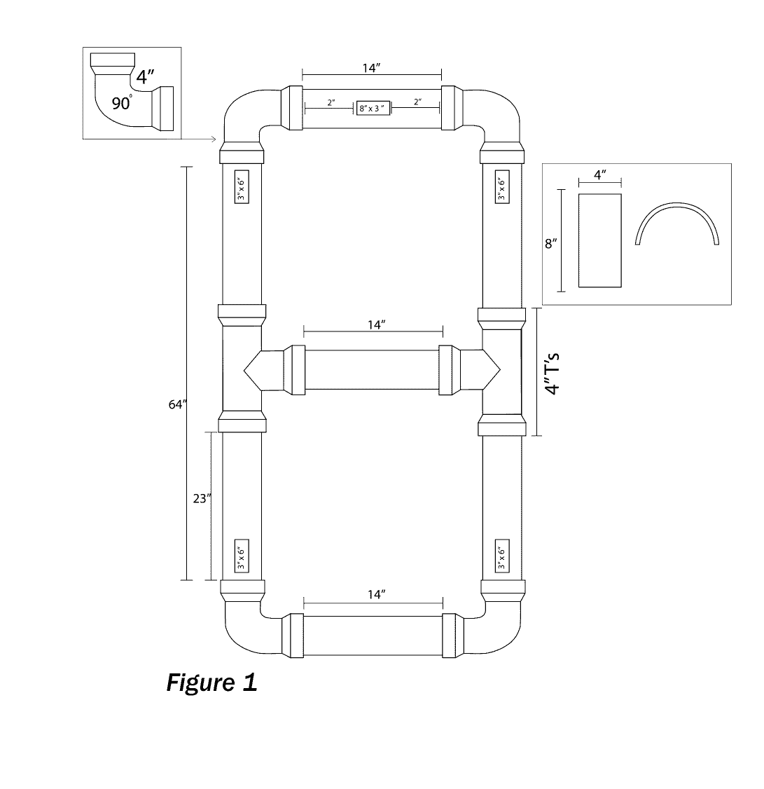

The machine contains 2, 4-inch wide water storage tanks tanks that include a filter each. Ref. FIG. 1

The water storage tanks also have removable viewing/maintence caps and windows. Ref. FIG. 2.

The machine contains 1-2 submersible pumps and air stone system, depending on size/capacity, water temperature thermometer also used as water line level. Ref. FIG. 2

The machine size ranges specific systems dimensions vary from different capacity systems example of a 3 plant sized design draft is included in this application. A side view is provided In FIG. 2 drawing and a top view is provided in FIG. 1.

The machine uses 4 directional jets, 2 of which are adjustable, per plant compartment. Ref. FIG. 2.

### SUMMARY

This machine hopes to provide an easier way to grow plants in environments with limited water and limited specialized skills that normally come with aeroponic growing.

1. The machine saves on water and nutrients compared to traditional growing in soil due to reduced evaporation and soil absorption.
E-45 grows plants from clones to harvest in 12 weeks or less.
The closed system reduces algae growth.
There is no need to flush the growing system for entire growth cycle, water only needs to be added when level is shown as low on included meter.
The inclusion of air stones aerate and circulate water.
The E-45 grow machine can be put together with no tools in 10-15 minutes.
